(19) United States
(12) Patent Application Publication
(10) Pub. No.: US 2009/0271950 A1
(43) Pub. Date: Nov. 5, 2009

(54) HANDLE STRUCTURE WITH LOCKING UNIT

(75) Inventor: Ting-Jui Wang, Sindian City (TW)

Correspondence Address: SCHMEISER, OLSEN & WATTS, 22 CENTURY HILL DRIVE, SUITE 302, LATHAM, NY, 12110, US

(73) Assignee: FIVETECH TECHNOLOGY INC., Sindian City (TW)

(21) Appl. No.: 12/113,342

(22) Filed: May 1, 2008

(51) Int. Cl. B25G 3/12

(52) U.S. Cl. 16/415

(57) ABSTRACT

A handle structure with locking unit includes a handle having a hollow fitting section provided at a predetermined position, a locking unit movably coupled with the handle, and an elastic element fitted around the rod section and restricted within the fitting section. The locking unit includes a rod section fitted in the fitting section of the handle, an operating section located at an end of the rod section to outward protrude from a first end of the fitting section, and a threaded section located at another end of the rod section to outward protrude from a second end of the fitting section. An annular stop section is formed around the rod section to interfere with the fitting section. When a slidable carrier unit with the handle structure mounted thereto is in a fully inward pushed position, the operating section may be turned to lock or unlock the carrier unit.

### FIELD OF THE INVENTION

The present invention relates to a handle structure, and more particularly to a handle structure with locking unit for mounting to a slidable carrier unit of a device. When the carrier unit with the handle structure mounted thereto is in a fully inward pushed position, the locking unit may be turned to lock or unlock the carrier unit to or from the device.

### BACKGROUND OF THE INVENTION

Many devices used in people's daily life, such as servers, cabinets, racks, etc., usually include one or more carrier units, such as chassis, drawers, and shelves for accommodating relevant things therein. The carrier unit can be slidably drawn out and pushed in along corresponding slide rails, allowing a user to easily position or remove things into or from the carrier unit for storage or necessary processing. A handle is usually mounted to a front surface of the slidable carrier unit for the user to easily draw out and push in the carrier unit.

However, in general, the handle is simply fixed to the front surface of the carrier unit by means of screws without any locking function. Therefore, in case of an earthquake, damaged slide rails, or inclined floor, the slidable carrier unit tends to unexpectedly slide outward. This may lead to damage of the things accommodated in the carrier unit.

### SUMMARY OF THE INVENTION

It is therefore a primary object of the present invention to provide a handle structure with locking unit for fixedly mounting to a slidable carrier unit of a device, so that the handle structure allows a user to conveniently draw out or push in the carrier unit, and lock or unlock the carrier unit when the carrier unit is in a fully inward pushed position.

According to the above and other objects, the handle structure with locking unit according to the present invention includes a handle having a hollow fitting section provided at a predetermined position, a locking unit movably coupled with the handle, and an elastic element fitted around the locking unit and restricted within the fitting section. The locking unit includes a rod section fitted in the fitting section of the handle, an operating section located at a first end of the rod section to outward protrude from a first end of the fitting section, and a threaded section located at a second end of the rod section to outward protrude from a second end of the fitting section. The elastic element is fitted around the rod section. And, an annular stop section is formed around the rod section at a predetermined position to interfere with the fitting section.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a handle structure with locking unit according to a first embodiment of the present invention;

FIG. 2 is an assembled view of FIG. 1;

FIG. 3 is an assembled sectional view of FIG. 1;

FIG. 4 is an assembled sectional view of a handle structure with locking unit according to a second embodiment of the present invention;

FIG. 5 is a perspective view showing a first manner of using the handle structure of the present invention; and

FIG. 6 is a perspective view showing a second manner of using the handle structure of the present invention.

### DETAILED DESCRIPTION OF THE PREFERRED EMBODIMENTS

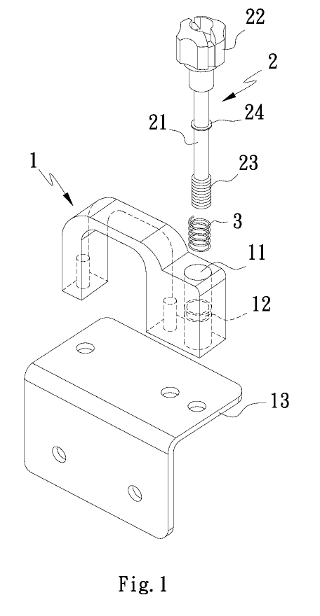

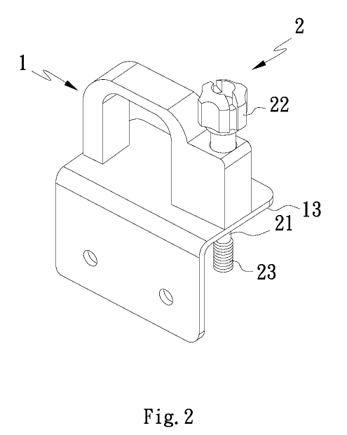

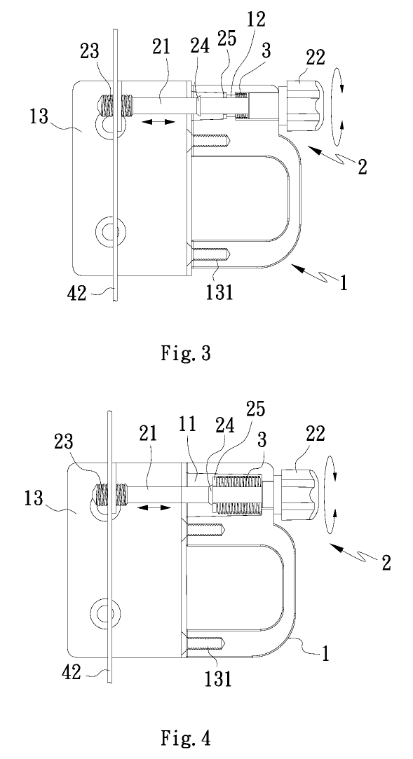

Please refer to FIGS. 1 and 2 that are exploded and assembled perspective views, respectively, of a handle structure with locking unit according to a first embodiment of the present invention, and to FIG. 3 that is an assembled sectional view of FIG. 1. As shown, the handle structure of the present invention includes a handle 1, a locking unit 2, and an elastic element 3.

The handle 1 has a hollow fitting section 11 arranged on a lateral side of the handle 1. A radially inward protruded annular restricting section 12 is formed in the fitting section 11 at a predetermined position. An angle bracket 13 is fixedly connectable to a rear side of the handle 1 by means of fastening elements 131.

The locking unit 2 is movably coupled with the handle 1. The locking unit 2 includes a rod section 21 fitted in the hollow fitting section 11 of the handle 1, an operating section 22 located at a first end of the rod section 21, and an externally threaded section 23 located at a second end of the rod section 21 opposite to the operating section 22. The operating section 22 is outward protruded from a first end of the fitting section 11, and the threaded section 23 is outward protruded from an opposite second end of the fitting section 11. An annular stop section 24 is formed around the rod section 21 at a predetermined position for interfering with the restricting section 12 in the fitting section 11. A washer 25 is mounted around the rod section 21 to locate at one side of the stop section 24 facing toward the first end of the fitting section 11. In the illustrated first embodiment, the washer 25 is located between the stop section 24 and the restricting section 12.

The elastic element 3 is fitted around the rod section 21. In the first embodiment of the present invention, the elastic element 3 is fitted around the rod section 21 with two ends of the elastic element 3 respectively abutted against the restricting section 12 and the operating section 22, as shown in FIG. 3. With the elastic element 3 located at this position, the operating section 22 is normally pushed outward by the elastic element 3, bringing the threaded section 23 of the locking unit 2 to a normally outward position. Alternatively, according to a second embodiment of the present invention as shown in FIG. 4, the first end of the fitting section 11 is radially inward extended, and the elastic element 3 is fitted around the rod section 21 with two ends of the elastic element 3 respectively abutted against the washer 25 placed on the stop section 24 and the first end of the fitting section 11. With the elastic element 3 located at this position, the rod section 21 is normally pushed inward by the elastic element 3, bringing the threaded section 23 of the locking unit 2 to a normally inward position.

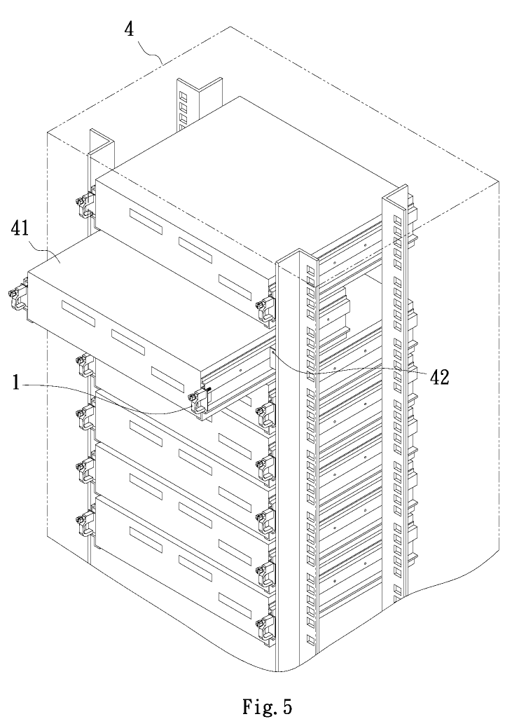

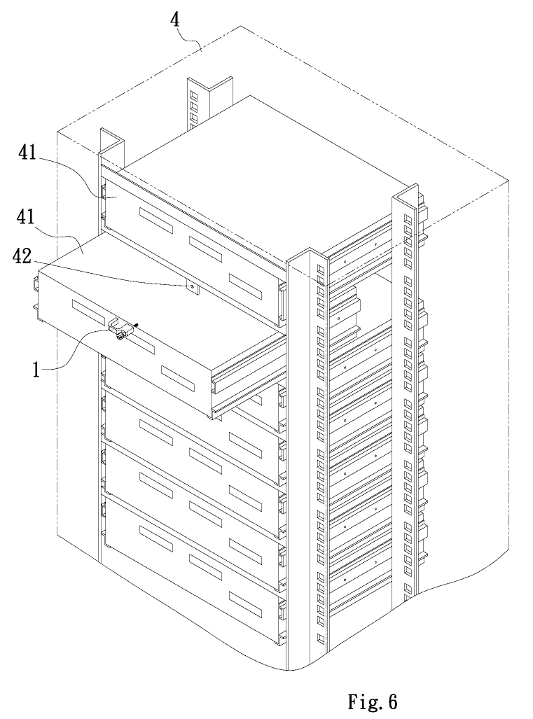

As an example, the handle structure of the present invention may be used on server chassis 41 slidably mounted on a server rack 4. In FIG. 5, the handle 1 of the handle structure of the present invention is fixedly connected via the angle bracket 13 to each of two lateral sides of the server chassis 41 on the server rack 4 using fastening elements (not shown). Alternatively, as shown in FIG. 6, the angle bracket 13 is omitted from the handle structure of the present invention, and the handle 1 is directly fixed to an upper front of the server chassis 41.

Please refer to FIGS. 5 and 6 along with FIGS. 3 and 4. In use, a user may grip at the handle 1 to draw or push the server chassis 41 out of or into the server rack 4. When the server chassis 41 is fully pushed into the server rack 4, the threaded section 23 of the locking unit 2 is aligned with a locking section 42 correspondingly provided on the server rack 4. At this point, the user may turn the operating section 22 to drive the rod section 21 and accordingly the threaded section 23 inward, so that the threaded section 23 is screwed into the locking section 42 to lock the server chassis 41 to the server rack 4. Under this circumstance, the elastic element 3 is compressed between the first end of the fitting section 11 and the washer 25 placed on the stop section 24 as shown in FIG. 4, or between the operating section 22 and the restricting section 12 as shown in FIG. 3.

When it is desired to draw out the server chassis 41 from the server rack 4, the user first turns the operating section 22 in a reverse direction to unscrew the threaded section 23 out of the locking section 42. At this point, the elastic element 3 is released from the compressed state. Then, the user may grip at the handle 1 to draw the server chassis 41 out of the server rack 4. Since the stop section 24 of the locking unit 2 would interfere with the restricting section 12 of the fitting section 11 while the operating section is turned to unlock the locking unit 2 from the server chassis 41, the locking unit 2 is prevented from moving out of the fitting section 11.

With the above arrangements, the handle structure of the present invention not only allows a user to conveniently draw and push a slidable carrier unit of a device, but also conveniently lock and unlock the carrier unit to and from the device without the risk of having a locking unit moved out of the handle structure. Therefore, the present invention is improved and practical for use to meet consumers' requirements.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A handle structure with locking unit, comprising:
a handle having a hollow fitting section formed at a predetermined position on the handle;
a locking unit being movably coupled with the handle, and including a rod section fitted in the fitting section of the handle, an operating section located at a first end of the rod section, and a threaded section located at a second end of the rod section opposite to the operating section; the operating section being outward protruded from a first end of the fitting section, and the threaded section being outward protruding from a second end of the fitting section;
and an annular stop section being formed around the rod section at a predetermined position to interfere with the fitting section; and
an elastic element being fitted around the rod section and restricted within the fitting section.

2. The handle structure with locking unit as claimed in claim 1, further comprising an angle bracket fixedly connectable to a rear side of the handle.

3. The handle structure with locking unit as claimed in claim 1, further comprising a washer mounted around the rod section to locate at one side of the stop section facing toward the first end of the fitting section.

4. The handle structure with locking unit as claimed in claim 1, wherein a radially inward protruded annular restricting section is formed in the fitting section at a predetermined position.

5. The handle structure with locking unit as claimed in claim 1, wherein the first end of the fitting section is radially inward extended, and the elastic element has two ends respectively abutted against the stop section and the first end of the fitting section.

6. The handle structure with locking unit as claimed in claim 4, wherein the elastic element has two ends respectively abutted against the restriction section and the operating section.
